(19) United States
(12) Patent Application Publication
(10) Pub. No.: US 2011/0209640 A1
(43) Pub. Date: Sep. 1, 2011

(54) METHOD OF FORMING THREE-DIMENSIONAL PATTERNS ON ARTICLE SURFACE

(76) Inventor: Chin Chen Chiu, Nantou (TW)

(21) Appl. No.: 12/887,203

(22) Filed: Sep. 21, 2010

(30) Foreign Application Priority Data
Feb. 26, 2010 (TW) 099105593

(51) Int. Cl. B41F 33/00

(52) U.S. Cl. 101/483

(57) ABSTRACT

The present invention relates to a method of forming three-dimensional patterns on an article surface, and in particular, a method of forming patterns having a lumpy feel on an article surface by hydraulic transfer printing method.

The present invention relates to a hydraulic transfer printing method, comprising the steps of forming a pattern layer having a desired pattern on a water-soluble film with a first paint, fully covering the pattern layer with a plate layer composed of a second paint to form a hydraulic transfer printing film, applying an activating agent to the plate layer, placing and spreading the hydraulic transfer printing film coated with the activating agent over water surface, then placed and spread over water surface, dipping substrates or articles into water against the activated hydraulic transfer printing film so the hydraulic transfer printing film would fully cover the substrates or articles to form the pattern on their surface, wherein the activating agent dissolves (can dissolve) the plate layer but not (cannot dissolve) the pattern layer.

### FIELD OF THE INVENTION

The present invention relates to a method of forming three-dimensional patterns on an article surface, and in particular, a method of forming patterns having a lumpy feel on an article surface by a hydraulic transfer printing method.

### BACKGROUND OF THE INVENTION

A conventional hydraulic transfer printing method is shown in FIG. 1. As illustrated, a pattern layer 12 is applied to a water-soluble film 11 such as PVA to form a hydraulic transfer printing film, and an activating agent layer 13 is then applied to the pattern layer 12. After the paints are activated, the hydraulic transfer printing film coated with the activating agent is floated on the water surface in a manner that the pattern layer 12 faces upwards. Subsequently, an article to be transfer printed 14 is pressed into water 15 to transfer print the pattern layer onto the surface of the article to be transfer printed 14. The pattern layer 12 and the activating agent layer 13 are cured and secured by irradiating a UV ray or heating (FIG. 1 shows the case of UV curing). After removing the water-soluble film 11 by rinsing, an article having a transfer printed pattern is obtained.

Recently, the technology of decorating an article surface by the hydraulic transfer printing method has been widely used onto automotive trim parts or exterior trim parts on household products; however, a new surface treatment technology that can adopt a lumpy feel to an article surface while conducting transfer printing is still to be expected in the industries.

Japan patent publication no. H6-040198 discloses a hydraulic transfer printing method in which wood flour is added into the paint to produce lumpy patterns onto an article surface. However, the shape of the lumpy pattern formed by this method is limited and wood flour may affect the quality of the transfer printed pattern.

Japan patent publication no. H7-276899 discloses a hydraulic transfer printing method in which a top coating is formed unevenly on the transfer printed pattern or a base coating is formed unevenly on the article to be transfer printed to make the article surface thus modified reveal a lumpy feel. However, this method suits only to the article having a top coating or a base coating applied thereto and needs additional operating steps.

WO 2009/054482 discloses a hydraulic transfer printing method to render a lumpy feel to an article surface. According to this method, a transfer printing film having an area formed by a pattern layer and an area free of pattern layer is coated with an activating agent, and when conducting the hydraulic transfer printing, surplus activating agent is concentrated on the area of the transfer printing film that is free of pattern layer to make the activating agent more raised than the pattern layer via the cohesive force of the activating agent itself and the repulsive force between the paint and the activating agent, thereby rendering a lumpy feel to the article surface.

### SUMMARY OF THE INVENTION

The main object of the present invention is to provide a hydraulic transfer printing method which is capable of rendering a lumpy feel to the article surface without additional operating steps.

The hydraulic transfer printing method, according to the present invention, comprises the steps of forming a pattern layer with a desired pattern on a water-soluble film with a first paint, fully covering the pattern layer with a plate layer composed of a second paint to form a hydraulic transfer printing film, applying an activating agent to the hydraulic transfer printing film, then placed and spread over water surface, dipping substrates into water against the activated hydraulic transfer printing film so the hydraulic transfer printing film would fully cover the substrates to form the pattern on their surface, wherein the activating agent dissolves (can dissolve) the plate layer but not (cannot dissolve) the pattern layer.

The method for forming the pattern layer and plate layer or applying the activating agent includes printing, spraying and roller coating.

Optionally, one or more decorative layers can be further formed between the pattern layer and the plate layer with a decorative paint, which can dissolve in the activating agent.

The activating agent is a ray curable activating agent preferred, and the most preferable is a UV ray curable or an electron beam curable one.

Also, the aforementioned expressions of “can dissolve” and “cannot dissolve” will be defined and described in more detail later in the text.

The present invention also provides a surface-decorated article with tactile patterns formed by the proposed hydraulic transfer printing method.

### EFFECTS OF THE INVENTION

According to the present invention, a pattern having a lumpy feel can be formed on an article surface by using a hydraulic transfer printing method without additional operating steps. In addition, as no other specific apparatus or operating steps are needed, the cost can be controlled to the same as that of the conventional hydraulic transfer printing method. Like the conventional hydraulic transfer printing method, the present invention can apply to automotive trim parts and the exterior of household products or housings of electronic products to give decorativeness and further improve the appearance of such articles or electronic products.

### BRIEF DESCRIPTION OF THE DRAWINGS

FIG. 1 shows the process of a conventional hydraulic transfer printing method.

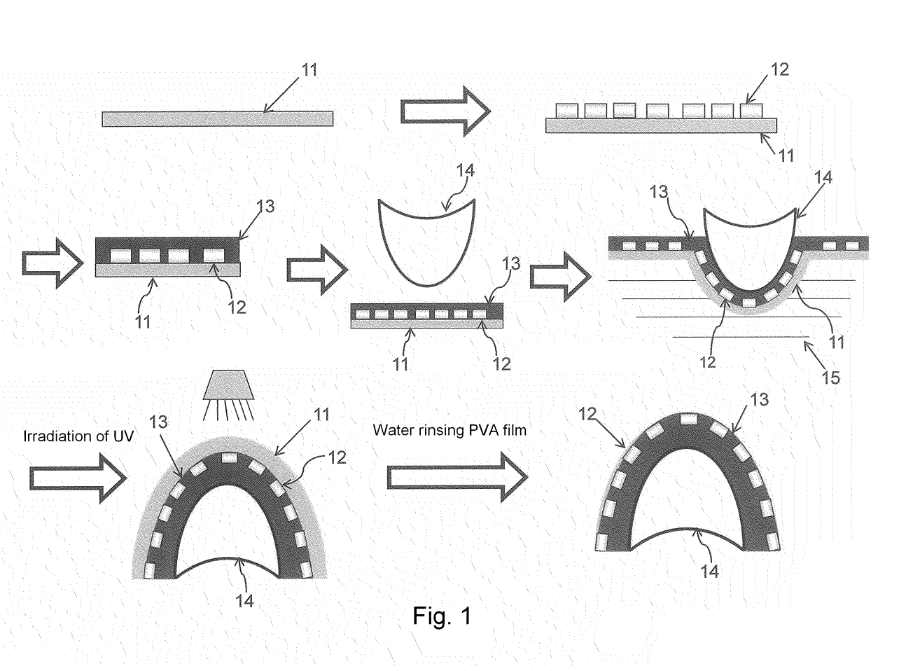

FIG. 2 shows the process of the hydraulic transfer printing method according to the present invention.

FIG. 3 is a schematic diagram showing the article and hydraulic transfer printing film in the course of conducting the hydraulic transfer printing method of the present invention.

FIG. 4 is a schematic diagram showing the article and hydraulic transfer printing film before conducting the hydraulic transfer printing method of the present invention.

FIG. 5 is a photo of the pattern on the article surface applied in Example 1 and a graph plotted by scanning the pattern with Alaph-step (partially shown), in which the direction parallel to the surface of the hydraulic transfer printing article was taken as the abscissa (mm) and the raised height of the surface pattern of the hydraulic transfer printing article was taken as the ordinate (μm).

### DESCRIPTION OF PREFERRED EMBODIMENTS

Below the hydraulic transfer printing method according to the present invention will be further described in detail.

The hydraulic transfer printing method according to the present invention comprises the following steps of:

(1) preparing a water-soluble film;
(2) forming a pattern layer having a desired pattern on the water-soluble film with a first paint;
(3) optionally forming one or more decorative layers on the pattern layer with a decorative paint;
(4) fully covering the pattern layer or the decorative layer with a plate layer composed of a second paint;
(5) applying an activating agent to the water-soluble film that has been processed by the aforementioned steps (hereinafter occasionally referred to as “hydraulic transfer printing film”), which then swells on water surface;
(6) placing a substrate to be transfer printed against the hydraulic transfer printing film coated with the activating agent and then pressing them into water so that the hydraulic transfer printing film covers the substrate surface;
(7) curing the patterns and the activating agent on the substrate with a UV ray or an electron beam; and
(8) removing the water-soluble film by water rinsing.

In the present invention, by properly selecting the first paint, second paint and activating agent (i.e. the first paint cannot dissolve in the activating agent while the second paint can dissolve in the activating agent) and making good use of the difference in solubility between the two paints in the activating agent, a tactile pattern can be formed on an article surface after hydraulic transfer printing process.

In the proposed that one or more decorative layers are between the pattern layer and the plate layer, the soluble decorative paint for forming the decorative layer can dissolve in the activating agent. The varieties that decorative layer formed on the article surface is either patterning or acts as full coating on demand on the transfer. The decorative layer enriches the transfer with richer surface patterns and color variants.

The term “dissolve” indicated in the present invention is defined below. A single layer of paint having a thickness of 1-2 μm is printed on or applied to a blank PVA film, an activating agent of 20 g/m² is applied thereto, and then a hydraulic transfer printing process is conducted. If the article surface can be fully covered by the activated hydraulic transfer printing film after the article is pressed into water, the activating agent is deemed “capable of dissolving” the paint; on the other hand, if folds and wrinkles occur on hydraulic transfer printing film and affects the article surface, namely, if the hydraulic transfer printing film fails to cover the article surface fully and smoothly, the activating agent is deemed “not capable of dissolving” the paint.

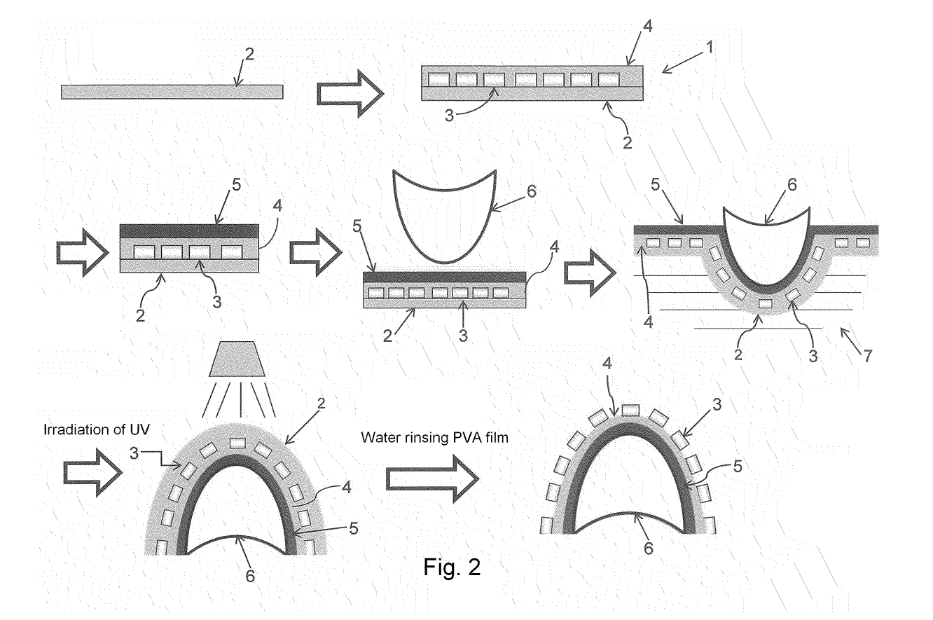

Referring to FIG. 2, the present invention is described in detail below.

FIG. 2 illustrates the detailed process of the hydraulic transfer printing method according to the present invention. For simplification, FIG. 2 only shows the most interested “pattern layer” and “plate layer” of a hydraulic transfer printing film without the optional “decorative layer.” In addition, in FIG. 2, an ultraviolet (UV) ray curable activating agent is used for example. In FIG. 2, a hydraulic transfer printing film 1 comprises a water-soluble film 2, a pattern layer 3 composed of a first paint, and a plate layer 4 composed of a second paint. On the water-soluble film 2, the pattern layer 3 is printed with desired pattern and thus the hydraulic transfer printing film is formed, and then the plate layer 4 is applied thoroughly onto the pattern layer 3. When conducting the hydraulic transfer printing, an activating agent is first applied to the whole plate layer 4 of the hydraulic transfer printing film 1 to form an activating agent layer 5. Subsequently, an article 6 against the hydraulic transfer printing film 1 coated with the activating agent layer 5, is pressed into water 7 so that the hydraulic transfer printing film covers the surface of the article 6 in a manner that the water-soluble film 2 faces outwardly, to transfer print the pattern onto the surface of the article 6. Subsequently, depending on the kind of the activating agent, the article 6 is properly treated by, for example, irradiating a UV ray or an electron beam (in the case of FIG. 2, the UV ray is irradiated) to cure the activating agent and pattern. Finally, the water-soluble film 2 is removed by water rinsing and the transferring process is completed.

In the present invention proposed, the tactile pattern on the article surface is achieved principally by the insolubility of the pattern layer 3 and the solubility of the plate layer 4 in the activating agent. So only the portion of the pattern layer traps and raises on the article surface after the hydraulic transfer printing process is completed. As to the reason that the proposed invention can produce a tactile pattern on an article surface, a conjecture made by the inventors is provided below.

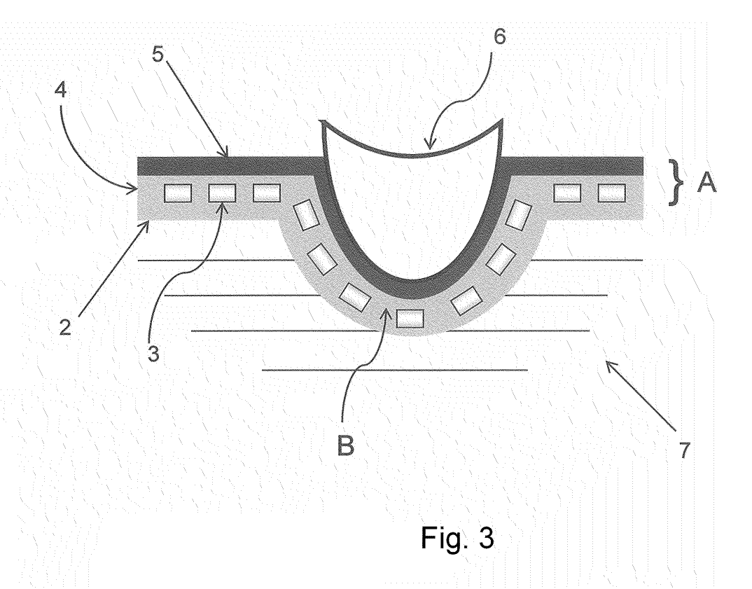

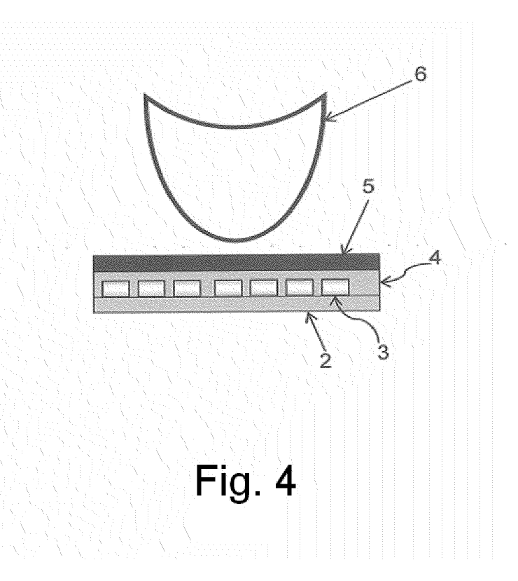

FIG. 3 is a schematic diagram showing rendering a pattern to the article 6 by using the hydraulic transfer printing method according to the present invention, and FIG. 4 is a schematic diagram showing the condition before the article is pressed into water. The pattern layer 3, plate layer 4, and activating agent layer 5, which is applied later, in the hydraulic transfer printing film 1 shown in FIG. 4 will combine one another as one layer (as represented by “A” in FIG. 3). As the first paint constituting the pattern layer 3 cannot dissolve in the activating agent, the first paint will keep its original form in the layer A and only the second paint constituting the plate layer will dissolve in the activating agent and form a mixture, in which the layer A will contain “the first paint” and “the solution of second paint in the activating agent.” Then the downward hydraulic pressure against the pressed article is the possible cause that the first paint is embedded in the water-soluble film 2 (namely, protruding over the interface between the water-soluble film 2 and the layer A, which is represented by “B” in FIG. 3). The mixture of plate layer 4 and activating agent layer 5 is cured with a proper method so as to fix the pattern layer 3, and a pattern composed of the pattern layer 3 can thus protrude over the surface of the article 6 after the removal of water-soluble film 2 by water rinsing.

In the present invention, the kind of the water-soluble film 2 is not specified and a general water-soluble film for the hydraulic transfer printing process such as, for example, a polyvinyl alcohol (PVA) film would be sufficient.

The first paint and second paint are not specified, any paint that can be used in the hydraulic transfer printing process and meets the aforementioned chemical relation to the activating agent can be used. In addition, if necessary, other appearance modifiers, for example, pearl concentrate can be added into the first paint and second paint.

The activating agent is selected highly in accordance with the solubility of the first paint and second paint used in the hydraulic transfer printing process.

The method for curing the activating agent depends on the kind of the activating agent, and an activating agent that can be cured by irradiating a UV ray or an electron beam is preferred.

When the present invention is conducted, the amount of coating activating agent is not specified, general use of amount in the industries such as 15-40 g/m² would be sufficient.

The method for applying the first paint, second paint and activating agent is not specified and can be any coating method used in general industries such as, for example, a printing method, a spraying method or a roller coating method.

According to the present invention, if there are decorative layers between the pattern layer and the plate layer, a desired quantity of decorative layers is optionally applied, after the first paint is applied, in a manner of patterning or fully covering (as stated above, the decorative paint can dissolve in the activating agent) and then the second paint is fully applied thereon. The method for applying the decorative paint is not specified either and can be any coating method used in general industries such as, for example, a printing method, a spraying method or a roller coating method.

Examples given below are used to concretely describe the present invention. However, the present invention should not be limited by the following examples. Various equivalent alterations and improvements made thereto by the skilled persons in the art could be conceived of without departing from the scope of the present invention.

### EXAMPLES

### Solubility of the Paint

A single layer of paint is printed or applied onto a blank PVA film at a thickness of about 1-2 μm and then an activating agent of 20 g/m² is applied thereto. The article is put into water to conduct the hydraulic transfer printing process. After the article is pressed into water, if its surface can be fully covered by the hydraulic transfer printing film that has been activated, the activating agent is deemed “capable of dissolving” the paint. On the other hand, if folds or wrinkles occur on the article surface, namely, if the hydraulic transfer printing film fails to fully cover the article surface, the activating agent is deemed “not capable of dissolving” the paint.

The following hydraulic transfer printing processes were conducted by using the inks and activating agent manufactured by the applicant. The inks as used are HR-AA, HR-APB, HR-BA and HR-BPB paints, and the activating agent as used is HR-UAc. After tested with the aforementioned solubility test, HR-AA and HR-APB paints, which have a blue nacreous luster on their appearances, were found “capable of dissolving” in the activating agent HR-UAc, while HR-BA and HR-BPB paints, which have a blue nacreous luster on their appearances, were found “not capable of dissolving” in the activating agent HR-UAc.

### Example 1

A pattern of HR-BA paint was formed on a blank PVA film by the printing method as a pattern layer, and then a plate layer was formed thereon by fully applying the HR-AA paint thereto with a roller coater for coverage, whereby a roll of hydraulic transfer printing film was prepared. A layer of activating agent HR-UAc was applied to the hydraulic transfer printing film at the coating amount of 30 g/m² by the spraying method. Then the hydraulic transfer printing process was conducted on an article made of acrylonitrile-butadiene-styrene (ABS), polycarbonate (PC) or an ABS/PC blend to obtain a hydraulic transfer printing article having a watermark printed pattern.

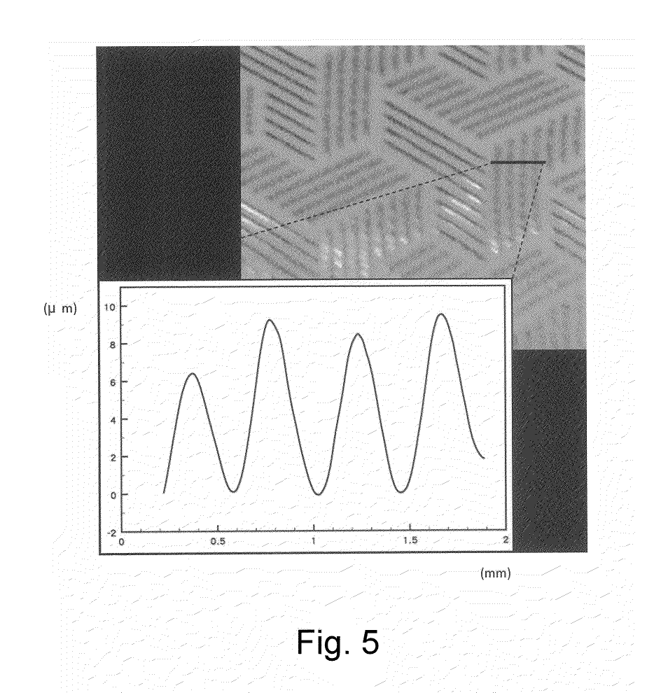

The pattern on the article surface was photographed with a Canon EOS7D camera, and scanned with an Alpha-step instrument (model: Dektak 150) made by Veeco Co. to obtain actual pattern height data of each spot of the article surface. Based on these data, a graph was plotted with the direction parallel to the article surface taken as the abscissa (mm) and the height of the surface pattern of the hydraulic transfer printing article taken as the ordinate (μm) and was partially shown in FIG. 5. The average height of raised portions throughout the pattern on the article surface was measured and the result was 11 μm.

### Example 2

A pattern of HR-BPB paint was formed on a blank PVA film by the printing method as a pattern layer, and then a plate layer was formed thereon by fully applying the HR-AA paint thereto with the roller coating method, whereby a roll of hydraulic transfer printing film was prepared. A layer of activating agent HR-UAc was applied to the hydraulic transfer printing film at the coating amount of 30 g/m² by the spraying method. Then the hydraulic transfer printing process was conducted on an article made of acrylonitrile-butadiene-styrene (ABS), polycarbonate (PC) or an ABS/PC blend to obtain a hydraulic transfer printing article with tactile patterns. The average height of raised portions throughout the pattern on the article surface was measured by the same method in Example 1 and the result was 8 μm.

### Comparative Example 1

A pattern of HR-APB paint was formed on a blank PVA film by the printing method as a pattern layer, and then a plate layer was formed thereon by fully applying the HR-AA paint thereto with a roller coater for coverage, whereby a roll of hydraulic transfer printing film was prepared. A layer of activating agent HR-UAc was applied to the hydraulic transfer printing film at the coating amount of 30 g/m² by the spraying method. Then the hydraulic transfer printing process was conducted on an article made of acrylonitrile-butadiene-styrene (ABS), polycarbonate (PC) or an ABS/PC blend to obtain a hydraulic transfer printing article having a planographic printed pattern that is similar to those obtained in a conventional hydraulic transfer printing process. The average height of the raised portions throughout the pattern on the article surface was measured by the same method in Example 1 and the result was 1 μm.

### Comparative Example 2

A pattern of HR-BPB paint was formed on a blank PVA film by the printing method as a pattern layer, and then a plate layer was formed thereon by fully applying the HR-BA paint thereto with a roller coater for coverage, whereby a roll of hydraulic transfer printing film was prepared. A layer of activating agent HR-UAc was applied to the hydraulic transfer printing film at the coating amount of 30 g/m² by the spraying method. Then the hydraulic transfer printing process was conducted on an article made of acrylonitrile-butadiene-styrene (ABS), polycarbonate (PC) or an ABS/PC blend; however, the film could not be activated and the hydraulic transfer printing process failed.

The results of Examples 1 and 2 and Comparative Examples 1 and 2 are listed in Table 1.

TABLE 1

| | Paint for | | | |
|---|---|---|---|---|
| | pattern | Paint for | Transfer printing | Average raised |
| No. | layer | plate layer | effect | height (μm) |
| Ex. 1 | HR-BA | HR-AA | The pattern layer has | 11 |
| | | | raised print texture, | |
| | | | which produces a 3D | |
| | | | watermark effect. | |
| Ex. 2 | HR-BPB | HR-AA | The pattern layer has | 8 |
| | | | raised print texture, | |
| | | | which produces a 3D | |
| | | | effect. | |
| CEx. 1 | HR-APB | HR-AA | Although there is | 1 |
| | | | print texture, yet no | |
| | | | 3D effect is produced. | |
| CEx. 2 | HR-BPB | HR-BA | Failed to conduct | — |
| | | | transfer printing. | |

It can be clearly seen from Table 1 that a tactile pattern can be formed on the article surface only when the HR-BA or HR-BPB paint, which cannot dissolve in the activating agent, is used as the pattern layer and the HR-AA paint, which can dissolve in the activating agent, is used as the plate layer in the hydraulic transfer printing process. In other words, only Examples 1 and 2, in which the paints for the pattern layer and plate layer and the activating agent meet the required solubility relation, can form a tactile pattern on the article surface While Comparative Examples 1 and 2, in which the paints for the pattern layer and plate layer and the activating agent do not meet the required solubility relation, cannot form a tactile pattern and even fail to be processed by hydraulic transfer printing process.

### INDUSTRIAL APPLICABILITY

The hydraulic transfer printing method according to the present invention can render a lumpy feel to the surface of a hydraulic transfer printing article and can be applied to automotive trim parts or exterior trim parts on household products or housings of electronic products to give decorativeness and further improve the appearance of such articles or electronic products. The hydraulic transfer printing method of the present invention needs neither additional operating steps nor specific materials and apparatus, can render a lumpy feel onto an article surface without increasing the cost of hydraulic transfer printing, can be used to produce more beautiful articles with tactile patterns, and thus has wider industrial uses for applications.

### DESCRIPTION OF REFERENCE NUMERALS

1 hydraulic transfer printing film
2, 11 water-soluble film
3, 12 pattern layer
4 plate layer
5, 13 activating agent layer
6, 14 article
7, 15 water
A a layer composed of pattern layer, plate layer and activating agent layer
B interface between water-soluble film and layer A

1. A hydraulic transfer printing method, comprising the steps of forming a pattern layer with a desired pattern on a water-soluble film with a first paint, fully covering the pattern layer with a plate layer composed of a second paint to form a hydraulic transfer printing film, applying an activating agent to the plate layer, placing and spreading the hydraulic transfer printing film coated with the activating agent over water surface, dipping an article to be transfer printed into water against the activated hydraulic transfer printing film so the hydraulic transfer printing film fully covers the article to form the pattern on its surface, wherein the activating agent can dissolve the plate layer but cannot dissolve the pattern layer.

2. The hydraulic transfer printing method according to claim 1, wherein a decorative layer formed of a decorative paint is further formed between the pattern layer and the plate layer, and the decorative paint can dissolve in the activating agent is either a printing method, a spraying method or a roller coating method.

3. The hydraulic transfer printing method according to claim 1, wherein the method for forming the pattern layer, plate layer and decorative layer or applying the activating agent is either a printing method, a spraying method or a roller coating method.

4. The hydraulic transfer printing method according to claim 1, wherein the activating agent is a ray curable activating agent that can be cured via ray.

5. The hydraulic transfer printing method according to claim 4, wherein the ray curable activating agent is a UV ray curable activating agent or an electron beam curable activating agent.

6. The hydraulic transfer printing method according to claim 1 wherein the surface of the article covered with the hydraulic transfer printing film has a lumpy feel.

7. The hydraulic transfer printing method according to claim 3, wherein the surface of the article covered with the hydraulic transfer printing film has a lumpy feel.

8. The hydraulic transfer printing method according to claim 4, wherein the surface of the article covered with the hydraulic transfer printing film has a lumpy feel.

9. The hydraulic transfer printing method according to claim 2, wherein the method for forming the pattern layer, plate layer and decorative layer or applying the activating agent is either a printing method, a spraying method or a roller coating method.

10. The hydraulic transfer printing method according to claim 2, wherein the activating agent is a ray curable activating agent that can be cured via ray.

11. The hydraulic transfer printing method according to claim 10, wherein the ray curable activating agent is a UV ray curable activating agent or an electron beam curable activating agent.

12. The hydraulic transfer printing method according to claim 2, wherein the surface of the article covered with the hydraulic transfer printing film has a lumpy feel.

13. The hydraulic transfer printing method according to claim 5, wherein the surface of the article covered with the hydraulic transfer printing film has a lumpy feel.

14. The hydraulic transfer printing method according to claim 11, wherein the surface of the article covered with the hydraulic transfer printing film has a lumpy feel.

15. The hydraulic transfer printing method according to claim 9, wherein the surface of the article covered with the hydraulic transfer printing film has a lumpy feel.

16. The hydraulic transfer printing method according to claim 10, wherein the surface of the article covered with the hydraulic transfer printing film has a lumpy feel.
